(19) United States
(12) Patent Application Publication
(10) Pub. No.: US 2007/0262573 A1
(43) Pub. Date: Nov. 15, 2007

(54) Steering device for a motor vehicle

(75) Inventors: Stefan Faeth, Aschaffenburg (DE); Matthias Helmstetter, Aschaffenburg (DE); Ralph Frisch, Moembris (DE); Toralf Mueller, Leverkusen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/801,001

(22) Filed: May 8, 2007

(30) Foreign Application Priority Data
May 12, 2006 (DE) 20 2006 007 751.0

(51) Int. Cl. B60R 21/203; B60R 21/26

(52) U.S. Cl. 280/731; 280/736

(57) ABSTRACT

A steering device (10) for a motor vehicle includes a steering wheel (12) and a gas bag (20) accommodated in the steering wheel (12). The steering wheel (12) is connected with a steering column (16) via a hub (14). The steering device (10) further includes a gas generator (22) which is able to be activated to fill the gas bag (20). The gas generator (22) is arranged on a side of the hub (14) facing away from the steering wheel (12) outside the steering column (16). The steering column (16) forms a part of a flow connection between the gas generator (22) and the gas bag (20) when the gas generator (22) is activated.

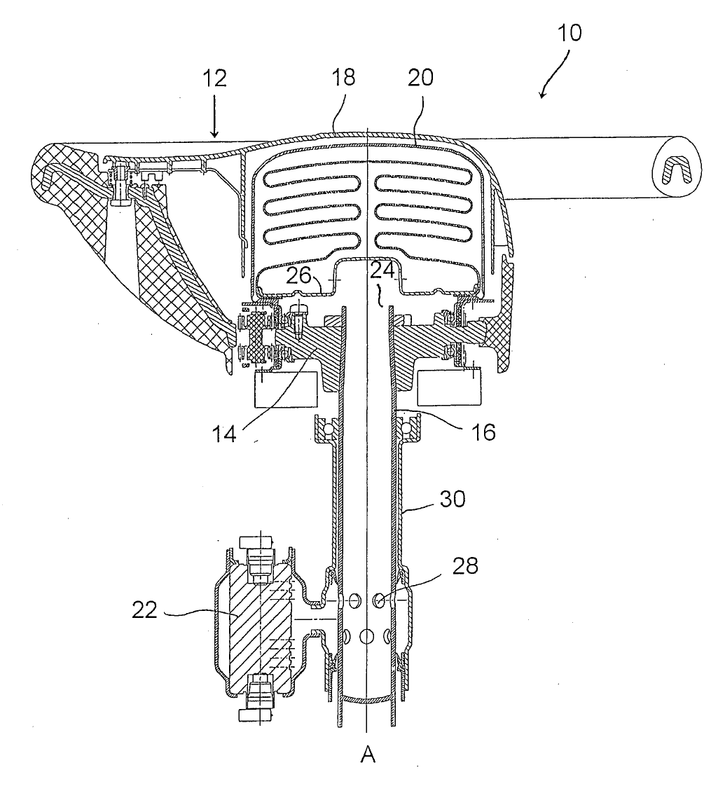

### TECHNICAL FIELD

The invention relates to a steering device for a motor vehicle.

### BACKGROUND OF THE INVENTION

Restraint systems for the driver of a motor vehicle are known, in which a gas bag module with a gas generator and an inflatable gas bag are accommodated directly in the steering wheel. Especially the gas generator requires a large structural space, such that the central part of the steering wheel can not be designed in any way which is desired.

Alternatively, the gas generator can be integrated into the steering column. Owing to the requirement for structural space by the gas generator, as already mentioned, the steering column must then have a certain minimum diameter, which results in a more complex connection of the steering column to the steering wheel hub. Solutions with a multiple-stage gas generator arranged inside the steering column are difficult to realize in this event.

It is an object of the invention to provide a restraint system on the driver's side, which allows more freedom of design with regard to the steering wheel.

### SUMMARY OF THE INVENTION

According to the invention, a steering device for a motor vehicle comprises a steering wheel and a gas bag accommodated in the steering wheel. The steering wheel is connected with a steering column via a hub. The steering device further comprises a gas generator which is able to be activated to fill the gas bag. The gas generator is arranged on a side of the hub facing away from the steering wheel outside the steering column. The steering column forms a part of a flow connection between the gas generator and the gas bag when the gas generator is activated.

The steering device according to the invention offers a range of advantages. The removal of the gas generator out from the steering wheel or the steering column makes a high degree of flexibility possible in the design of the steering wheel. Small steering wheels can therefore be developed without restricting the driver's safety, or the space which is gained can be used for other functions of the steering wheel. A rotary joint (helical spring) on the steering wheel hub for the electric leads to the gas generator is dispensed with. The displacement of the mass of the gas generator including the fastening elements into areas which are not critical with regard to vibration also improves the resonance situation of the steering wheel, so that in the best scenario a vibration damper which would otherwise be necessary can be dispensed with entirely.

A further advantage of the steering device according to the invention consists in that the handling during transportation, storage, installing or dismantling of the gas bag module (or of the individual components), and also the electrical contacting of the pyrotechnic gas generator is dispensed with. A permit for the gas bag module, e.g. by institutions for material testing, may no longer be necessary due to the absence of the gas generator.

The steering column, which serves as a gas conduit according to the invention, may be used—in particular by additional facilities provided therein—to damp the pressure impulse of the gas which is released from the gas generator, to filter unwanted particles from the gas and to cool the gas before contact with the gas bag.

### BRIEF DESCRIPTION OF THE DRAWING

In the drawing, the single FIGURE shows a sectional view of a steering device according to the invention.

### DETAILED DESCRIPTION OF THE PREFERRED EMBODIMENTS

The steering device 10 illustrated in the FIGURE comprises a steering wheel 12 with a hub 14 which is fastened non-rotatably to a hollow steering column 16. A folded gas bag 20 is accommodated in the steering wheel 12 underneath a covering 18.

A gas generator 22 which is able to be activated is arranged on the side of the hub 14 facing away from the steering wheel 12, outside the steering column 16. A flow connection exists between the gas generator 22 and the gas bag 20, this flow connection being produced by a suitable attachment of the gas generator 22 to the steering column 16 and its opening 24 on the steering wheel side. In addition, a diffusor 26 having outflow openings can be provided, which specifies the direction of the gas entering into the gas bag 20. In the embodiment illustrated in the Figure, the diffusor 26 also serves to clamp the gas bag 22 and therefore to seal the space between the hub 14 and the diffusor 26.

The gas generator 22 may either be securely connected with the steering column 16 such that it is co-rotated when the steering column 16 turns, or the gas generator 22 is fixed to the vehicle, such that a relative rotation between the steering column 16 and the gas generator 22 must be guaranteed. In the first case (non-rotatable arrangement of the gas generator 22 on the steering column 16), the electric leads of the gas generator 22 are connected by a commercial rotary joint (helical spring) with the electronic activation unit of the restraint system. In the second case (arrangement of the gas generator 22 so as to be fixed to the vehicle), no rotary joint is necessary. The flow connection for conducting gas from the gas generator 22 into the steering column 16 in this case is ensured by means of tight coupling contours (e.g. a flange) or a tight coupling element (e.g. a flexible pipe or a tube) and radial steering column openings 28 in the region of the gas generator 22. If further components (e.g. an outer column 30) have to be arranged between the gas generator 22 and the steering column 16 as a necessity of the construction, a tight conducting of the gas stream can be provided by suitable measures, e.g. additional coupling- and/or sealing elements.

As already mentioned, the steering column 16 is open on the steering wheel side. The opening 24 may, however, be closed by a closure which either opens passively at a certain pressure or can be actively opened by means of a control arrangement. The opposite end side of the steering column 16 is either closed permanently or by a mechanism which allows it to control the unfolding behaviour and oufflow behaviour of the gas bag 20 (active vent) by varying an opening cross-section and/or the point in time of opening.

Suitable materials may be introduced in the steering column 16, in order to cool and filter the gas generator discharge substances. The connection between the end of the steering column 16 on the steering wheel side and the gas bag 20 is constructed such that no, or only a small amount of the gas serving to inflate the gas bag 20 can escape. This may take place expediently by means of a flange-like connection or a seal, with a (prepared) part of the gas bag 20 being used as a seal, for example.

The gas flowing out from the steering column 16 towards the covering 18 is deflected by the diffusor 26 or another suitable contour such that the gas stream flows into the gas bag 20 radially—in relation to the steering axis A—or at an angle which is individually coordinated with the vehicle, in order to ensure an optimum unfolding behaviour with respect to an occupant who has been displaced forward or with respect to an obstacle. The diffusor 26 or the contour slows down particles which are accelerated in the steering column 16, or allows the particles to adhere to its surface, so that damage to the gas bag by accelerated particles is avoided.

1. A steering device for a motor vehicle, the steering device comprising a steering wheel and a gas bag accommodated in the steering wheel, the steering wheel being connected with a steering column via a hub, the steering device further comprising a gas generator which is able to be activated to fill the gas bag, the gas generator being arranged on a side of the hub facing away from the steering wheel outside the steering column, the steering column forming a part of a flow connection between the gas generator and the gas bag when the gas generator is activated.

2. The steering device according to claim 1, further comprising a diffuser which deflects gas provided by the gas generator and emerging from the steering column.

3. The steering device according to claim 1, wherein the gas generator is securely connected with the steering column.

4. The steering device according to claim 3, wherein electric leads of the gas generator are connected with an electronic activation unit by a rotary joint.

5. The steering device according to claim 1, wherein the gas generator is arranged so as to be fixed to the vehicle, a relative rotation being possible between the steering column and the gas generator.

6. The steering device according to claim 5, wherein coupling contours are provided for a flow connection between the gas generator and the steering column.

7. The steering device according to claim 6, wherein the coupling contours comprise a flange.

8. The steering device according to claim 5, wherein a coupling element is provided for a flow connection between the gas generator and the steering column.

9. The steering device according to claim 8, wherein the coupling element is one of a pipe and a tube.

10. The steering device according to claim 1, wherein the steering column has radial openings through which gas from the gas generator can enter into the steering column.

11. The steering device according to claim 1, wherein the steering column has an opening on a side facing the steering wheel, through which gas from the gas generator can enter into an interior of the steering wheel.

12. The steering device according to claim 11, wherein the opening is closed by a closure which opens passively at a certain pressure.

13. The steering device according to claim 11, wherein the opening is closed by a closure which can be opened actively by a control arrangement.

14. The steering device according to claim 1, wherein an end side of the steering column facing away from the steering wheel is permanently closed.

15. The steering device according to claim 1, wherein an end side of the steering column facing away from the steering wheel is closed by a mechanism with a variable opening cross-section and/or with a variable moment of opening.

16. A steering device according to claim 1, wherein an end side of the steering column facing away from the steering wheel is closed by a mechanism with a variable opening point in time.

17. The steering device according to claim 1, wherein an arrangement for filtering particles is provided in the steering column.

18. The steering device according to claim 1, wherein an arrangement for cooling gas from the gas generator is provided in the steering column.
